(19) United States
(12) Patent Application Publication
(10) Pub. No.: US 2025/0216636 A1
(43) Pub. Date: Jul. 3, 2025

(54) OPTICAL BRIDGE FOR PHOTONIC INTERPOSER TO PHOTONIC INTERPOSER COMMUNICATIONS

(71) Applicant: Intel Corporation, Santa Clara, CA (US)

(72) Inventors: Vinod ADIVARAHAN, Chandler, AZ (US); Liqiang CUI, Shenzhen, Guangdong (CN); Kristof DARMAWIKARTA, Chandler, AZ (US); Gang DUAN, Chandler, AZ (US); Benjamin DUONG, Phoenix, AZ (US); Shereen ELHALAWATY, Scottsdale, AZ (US); Sandeep GAAN, Chandler, AZ (US); Brandon C. MARIN, Gilbert, AZ (US); Srinivas V. PIETAMBARAM, Chandler, AZ (US); Marcel SAID, Portland, OR (US)

(21) Appl. No.: 18/853,973

(22) PCT Filed: Jun. 27, 2022
(86) PCT No.: PCT/CN2022/101425

§ 371 Date: Oct. 3, 2024

(51) Int. Cl. G02B 6/43; G02B 6/293; G02B 6/34; G02B 6/42

(52) U.S. Cl. CPC G02B 6/43; G02B 6/29331; G02B 6/34; G02B 6/4215; G02B 6/424; G02B 6/426; G02B 6/428

(57) ABSTRACT

Embodiments disclosed herein include photonics packages. In an embodiment, the photonics package comprises a substrate. In an embodiment, a first interposer is over the substrate, and a first die is on the first interposer. In an embodiment, a second interposer is over the substrate, and a second die is on the second interposer. In an embodiment, an optical bridge is between the first interposer and the second interposer.

### TECHNICAL FIELD

Embodiments of the present disclosure relate to photonics packages, and more particularly to photonics packages with photonics interposer to photonics interposer optical communication links.

### BACKGROUND

Advancements in electronic packaging are trending towards the use of disaggregated die architectures. That is, a plurality of dies are communicatively coupled together instead of requiring a single larger die, which is harder to manufacture. In existing disaggregated die architectures, the dies are communicatively coupled together by metal conductors fabricated on the package substrate/interposer or by the use of embedded bridges. Embedded bridges provide the ability to have high density routing between the dies.

However, signal loss significantly increases on metal conductors as the signaling frequency increases and the distance between dies increases. Furthermore, conductor routing for die to die communication becomes increasingly complex as more dies/chiplets are added to the package.

### BRIEF DESCRIPTION OF THE DRAWINGS

FIG. 1 is a perspective view illustration of a photonics package with a first photonics module and a second photonics module that are optically coupled together by optical bridges, in accordance with an embodiment.

FIG. 2A is a schematic illustration of a first die on a first photonics interposer that is optically coupled to a second die on a second photonics interposer with an optical bridge that has grating couplers, in accordance with an embodiment.

FIG. 2B is a schematic illustration of a first die on a first photonics interposer that is optically coupled to a second die on a second photonics interposer with an optical bridge that has evanescent couplers, in accordance with an embodiment.

FIG. 2C is a schematic illustration of a first die on a first photonics interposer that is optically coupled to a second die on a second photonics interposer with an optical bridge that includes a waveguide with a turn, in accordance with an embodiment.

FIG. 3A is a cross-sectional illustration of a substrate, in accordance with an embodiment.

FIG. 3B is a cross-sectional illustration of the substrate after a first photonics module and a second photonics module are coupled to the substrate, in accordance with an embodiment.

FIG. 3C is a cross-sectional illustration of the substrate after an optical bridge is provided on the first interposer and the second interposer, in accordance with an embodiment.

FIG. 3D is a cross-sectional illustration of the substrate after an underfill is provided between the first interposer and the second interposer below the optical bridge, in accordance with an embodiment.

FIG. 3E is a cross-sectional illustration of a photonics package with an optical bridge over and between the photonics interposers, in accordance with an embodiment.

FIG. 3F is a cross-sectional illustration of a photonics package with an optical bridge between the photonics interposers, in accordance with an embodiment.

FIG. 4A is a cross-sectional illustration of a photonics package with a first photonics module and a second photonics module on a substrate, in accordance with an embodiment.

FIG. 4B is a cross-sectional illustration of the photonics package after an optical bridge is formed in the substrate to optically couple the first photonics module to the second photonics module, in accordance with an embodiment.

FIG. 4C is a cross-sectional illustration of a photonics package with an optical bridge between the photonics interposers, in accordance with an embodiment.

FIG. 4D is a cross-sectional illustration of a photonics package with an optical bridge between the photonics interposers and into the base substrate, in accordance with an embodiment.

FIG. 5 is a cross-sectional illustration of a photonics system with a first photonics module coupled to a second photonics module by an optical bridge, in accordance with an embodiment.

FIG. 6 is a schematic of a computing device built in accordance with an embodiment.

### EMBODIMENTS OF THE PRESENT DISCLOSURE

Described herein are photonics packages with photonics interposer to photonics interposer optical communication links, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, disaggregated die architectures are increasing in popularity due, in part, to the difficulty of forming large form factor dies. However, the disaggregated die architecture creates issues with signaling between the dies. For example, signal loss significantly increases on metal conductors as the signaling frequency increases and the distance between dies increases. Furthermore, conductor routing for die to die communication becomes increasingly complex as more dies/chiplets are added to the package.

Accordingly, embodiments disclosed herein include photonics packages with photonics modules that are optically coupled to each other by optical bridges. In a particular embodiment, the photonics modules may include a plurality of dies (operating in an electric regime) that are optically coupled to each other by a photonics interposer. The photonics interposer may include photodetectors and modulators in order to convert between the electrical regime and the optical regime. In some embodiments the optical bridge is coupled to waveguides on the photonics interposer. For example, grating couplers, evanescent couplers, or the like may be used to optically couple the waveguides on the photonics interposer to waveguides on the optical bridge.

Operating in the optical regime has significant benefits over electrical interconnects. For example, the optical regime allows for higher signaling frequencies. In addition to enabling high signal frequencies, embodiments disclosed herein can also allow for the utilization of more digital modulation techniques (e.g., four-state quadrature amplitude modulator (QAM4), multiple access, etc.). Accordingly, the performance of the photonics package is increased compared to packages that operate entirely in the electrical regime.

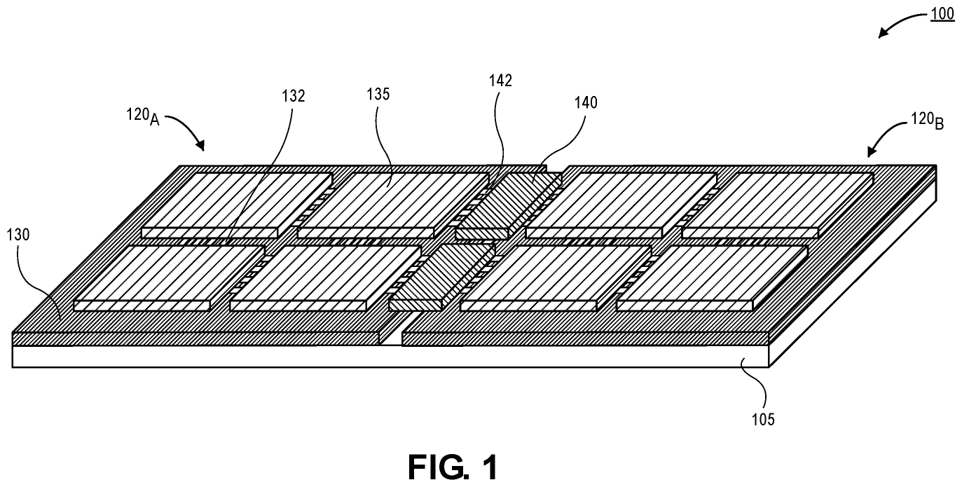

Referring now to FIG. 1, a perspective view illustration of a photonics package 100 is shown, in accordance with an embodiment. As used herein, a photonics package may refer to a package architecture that includes one or more optical interconnects (e.g., waveguides, optical coupling architectures, and the like). However, it is to be appreciated that not all interconnects need to be optical interconnects in order for a package to be considered a photonics package. Additionally, all of the components of the photonics package 100 need not operate in the optical regime. For example, dies 135 may operate in the electrical regime. The electrical signals to/from the dies 135 may be converted into optical signals by modulators, lasers, photodetectors, and the like.

In an embodiment, the photonics package 100 may comprise a base substrate 105. The base substrate 105 may be any type of packaging substrate. In a particular embodiment, the base substrate 105 may comprise glass. Though, in other embodiments, the base substrate 105 may comprise an organic material or a ceramic material. For example, the base substrate 105 may include organic buildup layers over and under a core. Conductive routing (not shown) may be provided through the base substrate 105 in some embodiments. The conductive routing may provide electrical connections to a board (not shown) that underlies the base substrate 105.

In an embodiment, a plurality of photonics modules 120 may be provided over the base substrate 105. For example a first photonics module 120_{A} and a second photonics module 120 are provided over the base substrate 105 in FIG. 1. However, it is to be appreciated that any number of photonics modules 120 may be provided over the base substrate 105, depending on the requirements of the photonics package 100. In an embodiment, each photonics module 120 may include a photonics interposer 130 and a plurality of dies 135.

In an embodiment, the photonics interposer 130 may include any substrate that is configured to allow for optical coupling between dies 135. For example optical interconnects 132 may be provided between the dies 135 on the photonics interposer 130. The interconnects 132 may be optical waveguides. For example, the photonics interposer 130 may comprise a silicon on insulator (SOI) substrate. Though, other materials and waveguides may also be used in alternative embodiments. In an embodiment, the photonics interposer 130 may also include functionality to convert electrical signals from the dies 135 into optical signals (for propagating along interconnects 132), and for converting optical signals back into electrical signals. For example, the photonics interposer 130 may comprise photodetectors, lasers, modulators, and the like. In certain embodiments, one or more of the photonics components (e.g., the laser) may be provided off of the photonics interposer 130.

In an embodiment, the plurality of dies 135 may include any type of compute die. For example, the plurality of dies 135 may include central processing units (CPUs), graphics processing units (GPUs), systems on a chip (SoC), or any other type of die that performs logic operations. In other embodiments, one or more of the plurality of dies 135 may comprise memory dies. In a particular embodiment, each of the plurality of dies 135 may be substantially similar to each other. In an embodiment, the plurality of dies 135 may include two or more dies 135. For example, a set of four dies 135 are provided in each photonics module 120. Though, it is to be appreciated that more than four dies 135 may be included in other embodiments. Additionally, the number of dies 135 in the first photonics module 120_{A} may be equal to the number of dies 135 in the second photonics module 120_{B}. In other embodiments, the number of dies 135 in the first photonics module 120_{A} may be different than the number of dies 135 in the second photonics module 120_{B}.

In an embodiment, the photonics package 100 may include one or more optical bridges 140. In FIG. 1, a pair of optical bridges 140 are shown. Though, it is to be appreciated that any number of optical bridges 140 may be used. The optical bridges 140 optically couple the first photonics module 120_{A} to the second photonics module 120_{B}. As such, dies 135 on the first photonics module 120_{A} can be communicatively coupled to dies 135 on the second photonics module 120_{B}.

In a particular embodiment, the optical bridge 140 may include optical waveguides (not shown). The optical waveguides may be optically coupled to the waveguides 142 on the photonics interposers 130. Any suitable optical coupling architecture (e.g., grating coupling, evanescent coupling, butt coupling, or the like) may be used. In an embodiment, the optical bridges 140 may be glass substrates with optical waveguides patterned into the glass substrates. Though other material regimes may also be used in order to provide optical waveguides.

In an embodiment, the optical bridges 140 may be provided between the first photonics module 120_{A} and the second photonics module 120_{B}. For example, the optical bridges 140 in FIG. 1 span across a gap between the photonics interposers 130 of the first photonics module 120_{A} and the second photonics module 120_{B}. That is, a portion of the optical bridges 140 may be between the photonics interposers 130 and portions of the optical bridges 140 may be over top surfaces of the photonics interposers 130. In other embodiments (described in greater detail below), the optical bridge 140 may be provided in the base substrate 105 or embedded in the base substrate 105.

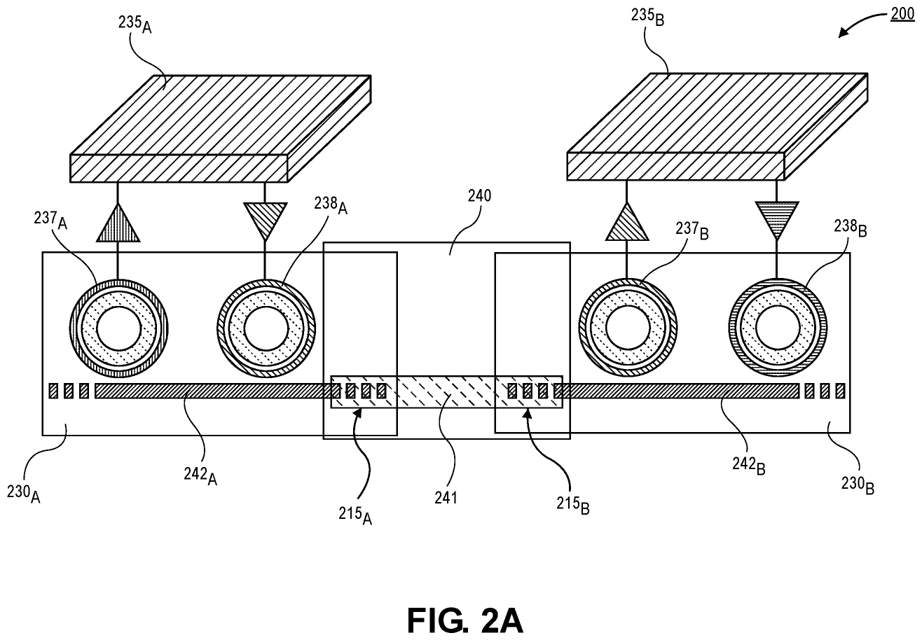

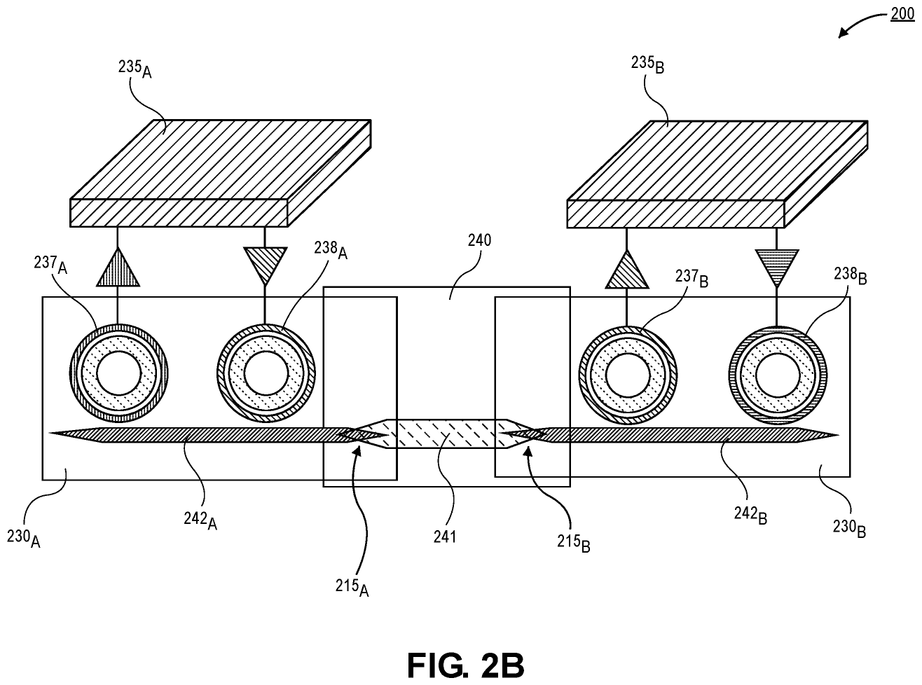

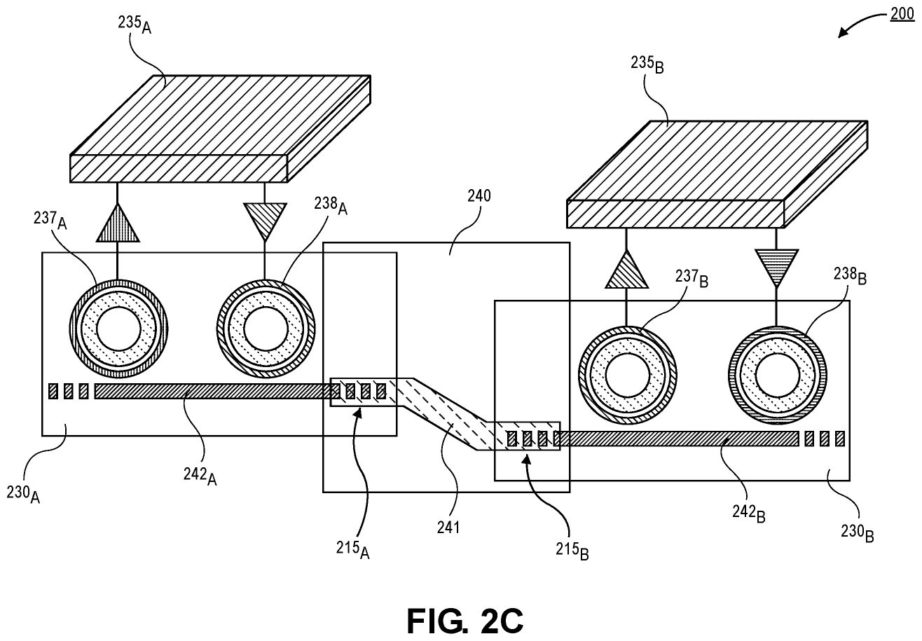

Referring now to FIG. 2A, a schematic illustration of a photonics package 200 is shown, in accordance with an embodiment. In an embodiment, the photonics package 200 may include a first die 235_{A} and a second die 235_{B}. The first die 235_{A} may be coupled to a first photonics interposer 230_{A}, and the second die 235_{B} may be coupled to a second photonics interposer 230_{B}. For example, the photonics interposers 230 may include photodetectors 237_{A} and 237_{B} and modulators 238_{A} and 238_{B}. The photodetectors 237 and modulators 238 allow for the electrical signals of the dies 235 to be converted into optical signals. The optical signals may be propagated along waveguides 242_{A} and 242_{B}. The photodetectors 237 may be microring photodetectors, and the modulators 238 may be microring modulators. Though, it is to be appreciated that any photodetector or modulator architecture may be used.

In an embodiment, the first photonics interposer 230_{A} may be optically coupled to the second photonics interposer 230_{B} by an optical bridge 240. In an embodiment, the optical bridge 240 may include a substrate and a waveguide 241 that is embedded within the substrate. In a particular embodiment, the substrate may be glass, and the waveguide 241 may also be glass. For example, a microstructure of the waveguide 241 may be different than a microstructure of the substrate. As such, total internal reflection may be provided in the waveguide 241 due to different refractive indexes. While glass is provided as one example, it is to be appreciated that the optical waveguide 241 may be implemented from any suitable waveguide/cladding material combinations, such as those comprising silicon or silicon and nitrogen (e.g., SiN).

In an embodiment, the optical waveguide 241 may be optically coupled to the waveguides 242_{A} and 242_{B} using any coupling architecture 215. In a particular embodiment, the optical coupling architecture may be grating couplers 215_{A} and 215_{B}. That is, a grating on the waveguides 242_{A} and 242_{B} may be used to propagate the optical signal in the adjacent waveguide 241.

In the schematic illustration shown in FIG. 2A, a single interconnect between a first die 235_{A} and a second die 235_{B} is shown for simplicity. It is to be appreciated that multiple optical interconnects may be provided across the optical bridge 240. That is, a plurality of waveguides 241 may be used to provide multiple interconnects between the first die 235_{A} and the second die 235_{B}. Additionally, a single optical bridge 240 may include optical interconnects between multiple different die 235 pairs.

Referring now to FIG. 2B, a schematic view illustration of a photonics package 200 is shown, in accordance with an additional embodiment. In an embodiment, the photonics package 200 in FIG. 2B may be substantially similar to the photonics package 200 in FIG. 2A, with the exception of the optical bridge 240. That is, the photonics package 200 may include a pair of dies 235_{A} and 235_{B} that are optically coupled to each other through photonics interposers 230_{A} and 230_{B}. In an embodiment, the photonics interposers 230_{A} and 230_{B} may be optically coupled to each other through an optical bridge 240.

In an embodiment, the optical bridge 240 may include a substrate and an optical waveguide 241. The optical waveguide 241 and the substrate may comprise glass in some embodiments. Though, other material combinations may also be used for the optical bridge 240. In an embodiment, the waveguide 241 of the optical bridge 240 may be optically coupled to the waveguides 242_{A} and 242_{B} on the photonics interposers 230_{A} and 230_{B} by an optical coupling architecture 215. In the particular embodiment shown in FIG. 2B, the optical coupling architectures 215_{A} and 215_{B} are evanescent coupling architectures. While evanescent couplers (FIG. 2B) and grating couplers (FIG. 2A) are shown as specific examples, it is to be appreciated that any optical coupling architecture may be provided between the optical bridge 240 and the photonics interposers 230. For example, butt coupling, or any other type of coupling may be used.

Referring now to FIG. 2C, a schematic view illustration of a photonics package 200 is shown, in accordance with an additional embodiment. In an embodiment, the photonics package 200 in FIG. 2C may be substantially similar to the photonics package 200 in FIG. 2A, with the exception of the optical bridge 240. That is, the photonics package 200 may include a pair of dies 235_{A} and 235_{B} that are optically coupled to each other through photonics interposers 230_{A} and 230_{B}. In an embodiment, the photonics interposers 230_{A} and 230_{B} may be optically coupled to each other through an optical bridge 240.

In an embodiment, the optical bridge 240 may comprise a substrate and a waveguide 241 that is embedded in the substrate. In contrast to the waveguides 241 described above, the waveguide 241 in FIG. 2C includes one or more turns or bends. The non-linear nature of the waveguide 241 allows for any misalignment between the waveguide 242_{A} and the waveguide 242_{B} to be mitigated in order to allow for improved coupling. For example, the first photonics interposer 230_{A} may be misaligned with the second photonics interposer 230_{B}. As such, the waveguide 241 may include one or more bends in order to bring the waveguides 242_{A} and 242_{B} back into alignment.

In one embodiment, the non-linear waveguide 241 may be formed with a laser direct writing process. In such an embodiment, a blank optical bridge 240 may be provided between the first photonics interposer 230_{A} and the second photonics interposer 230_{B}. An optical imaging system may then determine any offset between the first photonics interposer 230_{A} and the second photonics interposer 230_{B}. The optical imaging can be used to inform a direct laser write system that can then pattern the waveguide 241 into the optical bridge 240 in order to mitigate the misalignment between the first photonics interposer 230_{A} and the second photonics interposer 230_{B}. In the illustrated embodiment, grating couplers 215_{A} and 215_{B} are shown as the coupling mechanism. However, it is to be appreciated that non-linear waveguides 241 may include any coupling architecture (e.g., grating couplers, evanescent couplers, butt couplers, etc.).

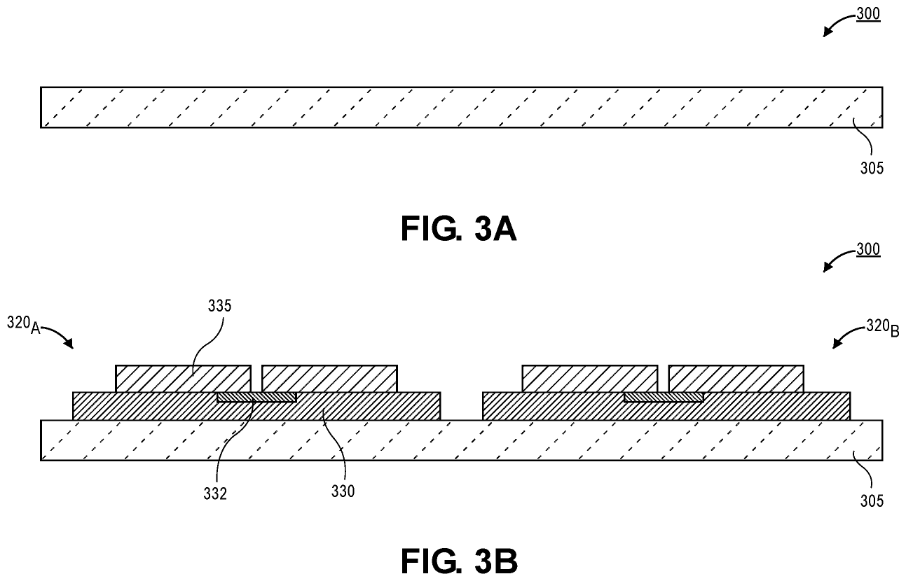

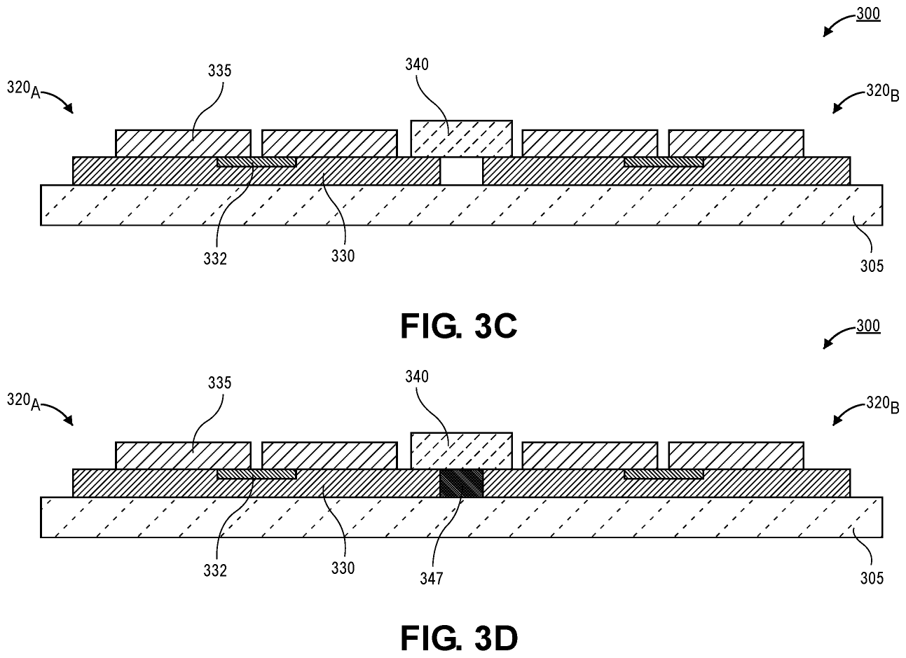

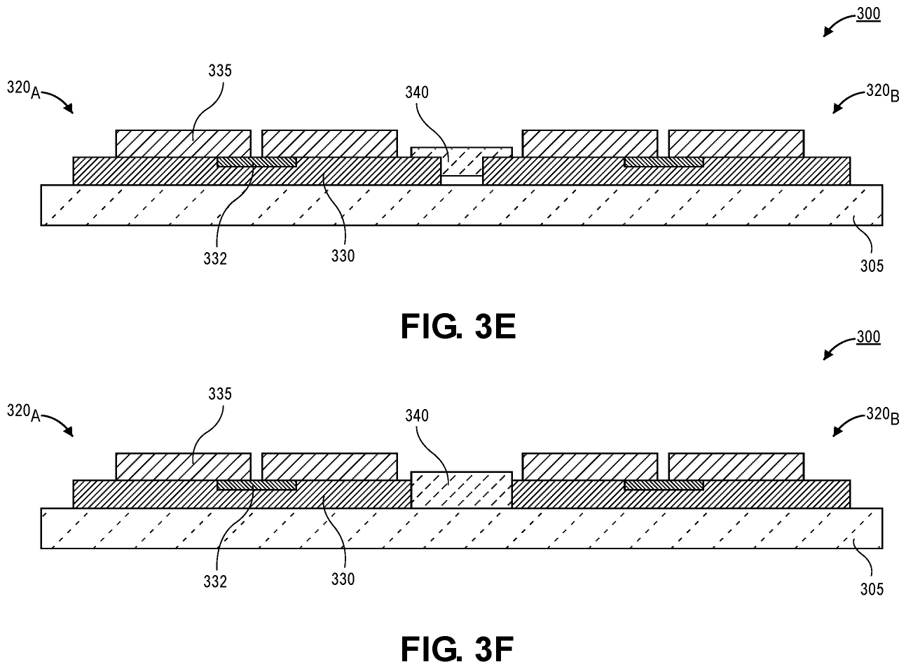

Referring now to FIGS. 3A-3D, a series of cross-sectional illustrations depicting a process for forming a photonics package 300 is shown, in accordance with an embodiment. In an embodiment, the photonics package 300 is shown with a generic optical bridge 340. However, it is to be appreciated that the optical bridge 340 may be substantially similar to any of the optical bridges described in greater detail herein.

Referring now to FIG. 3A, a cross-sectional illustration of the photonics package 300 at a stage of manufacture is shown, in accordance with an embodiment. In an embodiment, the photonics package 300 may comprise a base substrate 305. In an embodiment, the base substrate 305 may be any packaging substrate. In a particular embodiment, the base substrate 305 is a glass substrate. In the illustrated embodiment, no buildup layers, redistribution layers, conductive routing, and the like are shown for simplicity. However, it is to be appreciated that other conductive routing (e.g., pads, traces, vias, etc.) and layers may be included on the base substrate 305. While the base substrate 305 is described as being a glass substrate, it is to be appreciated that other embodiments may include organic base substrates 305 or ceramic base substrates 305. For example, organic buildup layers may be provided above and below an organic core material. The organic core material may include reinforcement, such as glass fibers or the like.

Referring now to FIG. 3B, a cross-sectional illustration of the photonics package 300 after photonics modules 320_{A} and 320_{B} are attached is shown, in accordance with an embodiment. In an embodiment, two photonics modules 320_{A} and 320_{B} are shown. However, it is to be appreciated that any number of photonics modules 320 may be attached to the base substrate 305. In the illustrated embodiment, the photonics modules 320 are directly contacting the base substrate 305. In some embodiments, interconnects (e.g., solder balls or the like) may be provided between the photonics modules 320 and the base substrate 305.

In an embodiment, the photonics modules 320 may each comprise a photonics interposer 330. The photonics interposers 330 may comprise functionality to convert electrical signals to optical signals and vice versa. For example, the photonics interposers 330 may comprise photodetectors, lasers, modulators, and the like. Such components are omitted from FIG. 3B in the sake of simplicity. In an embodiment, the photonics interposers 330 may also comprise optical waveguides 332. For example, optical waveguides 332 may be used to optically couple together dies 335 that are provided on the photonics interposers 330.

In an embodiment, two or more dies 335 may be provided on each of the photonics interposers 330. The dies 335 may be compute dies (e.g., CPUs, GPUs, SoCs, etc.) or memory dies. In the illustrated embodiment, the dies 335 are shown as being directly in contact with the underlying photonics interposers 330. However, it is to be appreciated that interconnects (e.g., first level interconnects (FLIs) or the like) may be provided between the dies 335 and the photonics interposers 330.

Referring now to FIG. 3C, a cross-sectional illustration of the photonics package 300 after an optical bridge 340 is attached is shown, in accordance with an embodiment. In an embodiment, the optical bridge 340 is used to optically couple the first photonics module 320_{A} to the second photonics module 320_{B}. The optical bridge 340 may be provided between the photonics interposers 330 of each photonics module 320. In a particular embodiment, the optical bridge 340 spans across a gap between the photonics interposers 330. The optical bridge 340 may be provided on top surfaces of the photonics interposers 330. In the illustrated embodiment, a single optical bridge 340 is shown. However, it is to be appreciated that multiple optical bridges 340 may be provided between the photonics modules 320_{A} and 320_{B}. Additionally, it is to be appreciated that the multiple optical bridges 340 may be similar to each other or have different structures (e.g., different patterning sizes, etc.).

In an embodiment, the optical bridge 340 may be substantially similar to any of the optical bridges described in greater detail above. For example, the optical bridge 340 may comprise a substrate with one or more optical waveguides embedded in the substrate. The optical waveguides are omitted from FIG. 3C for simplicity. In an embodiment, the optical waveguides may be optically coupled to waveguides on the photonics interposers 330. For example, the optical coupling may be implemented with grating couplers, evanescent couplers, butt couplers, or any other coupling architecture.

In an embodiment, the optical bridge 340 may comprise glass. The substrate may be glass with a first microstructure, and the optical waveguide may be glass with a second microstructure that is different than the first microstructure. The different microstructures result in different refractive indexes that enables total internal reflection. While glass is particularly described as being used for the optical bridge 340, other materials may also be used, such as silicon, silicon and nitrogen (e.g., SiN), and the like.

In an embodiment, the waveguide in the optical bridge 340 may be fabricated before the optical bridge 340 is added to the photonics package 300. In other embodiments, a blank optical bridge 340 may be attached to the photonics package 300. After attaching the optical bridge 340, direct laser writing may be used to form the optical waveguides in the optical bridge 340. Direct laser writing embodiments allow for any misalignment between the first photonics module 320_{A} and the second photonics module 320_{B} to be mitigated. As such, improved optical coupling between the photonics modules 320 may be provided.

Referring now to FIG. 3D, a cross-sectional illustration of the photonics package 300 after an underfill 347 is applied is shown, in accordance with an embodiment. In an embodiment, the underfill 347 may be an organic material, an epoxy, or any other suitable underfill material. The underfill 347 may be provided in the gap between the photonics interposers 330. The underfill 347 may also contact a bottom surface of the optical bridge 340 in some embodiments. The underfill 347 may also extend up sidewalls of the optical bridge 340. In some embodiments, the underfill 347 may be omitted.

Referring now to FIG. 3E, a cross-sectional illustration of a photonics package 300 is shown, in accordance with an additional embodiment. As shown, the optical bridge 340 is placed on top of the photonics interposers 330 and also extends down into the gap between the photonics interposers 330. In the illustrated embodiment, a bottom of the optical bridge 340 is above the top surface of the base substrate 305. However, in other embodiments, the bottom of the optical bridge 340 may be on the base substrate 305. Such an embodiment, is particularly beneficial for butt coupling architectures. In an embodiment, any gap between the base substrate 305 and the optical bridge 340 may be filled with air, index matching epoxy, or an underfill.

Referring now to FIG. 3F, a cross-sectional illustration of a photonics package 300 is shown, in accordance with yet another embodiment. As shown, the optical bridge 340 is placed on the base substrate 305 between the photonics interposers 330. In an embodiment, the height of the optical bridge 340 may be the same as the photonics interposers 330 or taller than the photonics interposers 330. Any gap between the photonics interposers 330 and the optical bridge 340, if present, may be filled with an index matching epoxy in some embodiments.

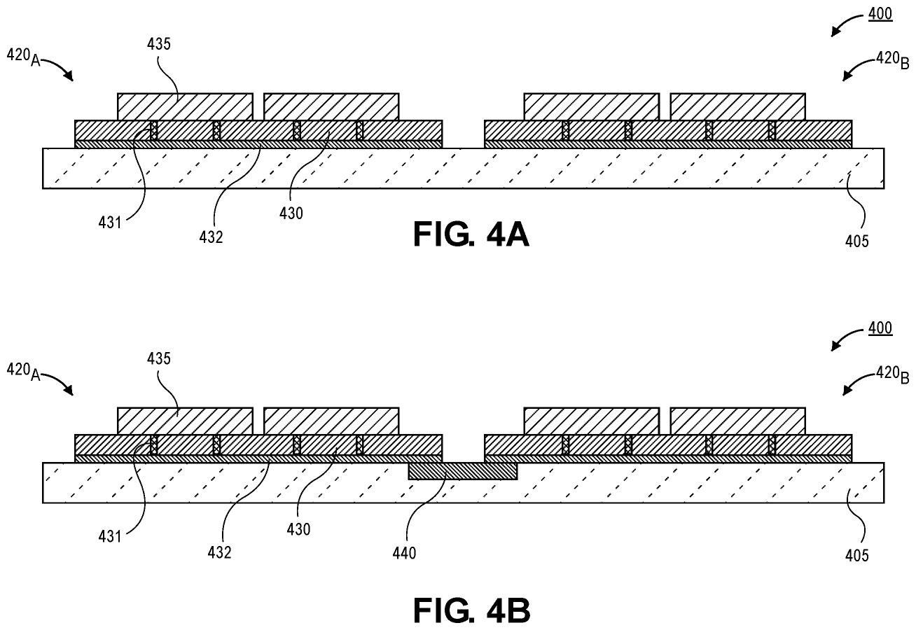

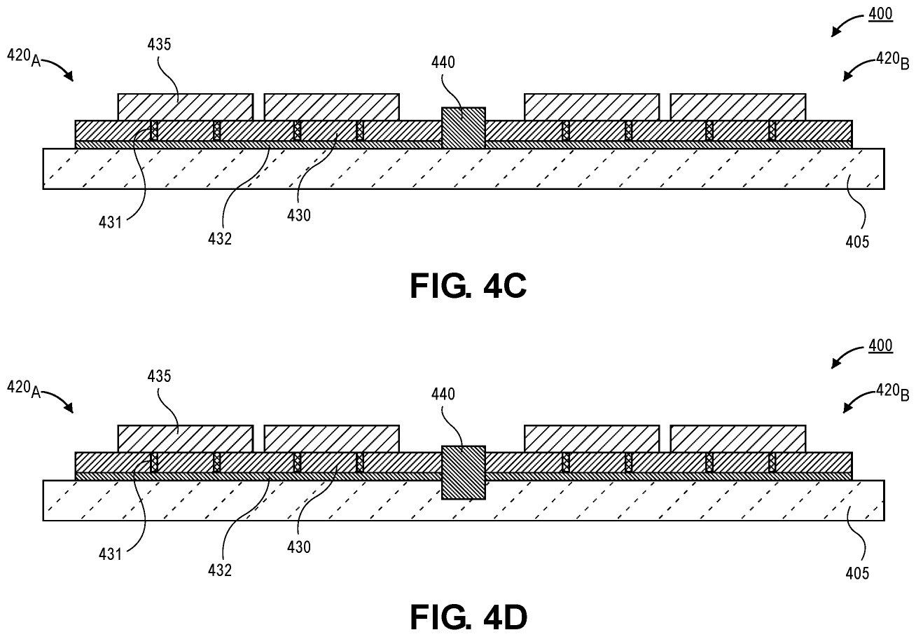

Referring now to FIGS. 4A-4B, a series of cross-sectional illustrations depicting a process for forming a photonics package 400 is shown, in accordance with an embodiment. Instead of providing the optical bridge 440 over the photonics interposers 430, the optical bridge 440 is provided in the base substrate 405.

Referring now to FIG. 4A, a cross-sectional illustration of a photonics package 400 is shown, in accordance with an embodiment. In an embodiment, the photonics package 400 may include a base substrate 405. The base substrate 405 may comprise glass or any other suitable substrate material (or materials). In an embodiment, a pair of photonics modules 420_{A} and 420_{B} are provided over the base substrate 405. While two photonics module 420 are shown, it is to be appreciated that any number of photonics modules 420 may be provided on the base substrate 405.

The photonics modules 420 may each comprise a photonics interposer 430 and a plurality of dies 435. The dies 435 may be optically coupled to each other through silicon photonics layer 432 in the photonics interposer 430. The silicon photonics layer 432 may include waveguides, active components, and the like. In an embodiment, the silicon photonics layer 432 is electrically coupled to the dies 435 by vias 431. In an embodiment, the photonics interposers 430 and the dies 435 may be substantially similar to photonics interposers 330 and dies 335 described in greater detail above.

Referring now to FIG. 4B, a cross-sectional illustration of the photonics package 400 after an optical bridge 440 is formed is shown, in accordance with an embodiment. When the base substrate 405 comprises glass, the optical bridge 440 may be formed by direct laser writing waveguides (not shown) into the base substrate 405. That is, the optical bridge 440 may be considered as part of the base substrate 405 in some embodiments. The use of direct laser writing allows for any misalignment between the photonics modules 420 to be mitigated. This allows for improved optical coupling between the photonics modules 420.

While an optical bridge 440 that is part of the base substrate 405 is shown in FIG. 4B, it is to be appreciated that discrete optical bridges 440 may also be provided below the photonics modules 420. For example, a cavity can be provided in the base substrate 405, and the optical bridge 440 may be placed in the cavity. In such an embodiment, the optical bridge 440 may be referred to as being embedded or partially embedded in the base substrate 405. Such an embodiment may be particularly beneficial when the base substrate 405 comprises an organic material or a ceramic material.

Referring now to FIG. 4C, a cross-sectional illustration of a photonics package 400 is shown, in accordance with an additional embodiment. As shown, the optical bridge 440 is provided over the base substrate 405 between the photonics interposers 430. The optical bridge 440 may extend up past a top surface of the photonics interposers 430. In other embodiments, the top of the optical bridge 440 may be coplanar with a top of the photonics interposers 430 or below a top of the photonics interposers 430. Additionally, any gap between the optical bridge 440 and the base substrate 405 may be filled with air, an index matching epoxy, or an underfill.

In yet another embodiment shown in FIG. 4D, the optical bridge 440 may be provided in a cavity in the base substrate 405. The optical bridge 440 may extend up past a top surface of the photonics interposers 430. In other embodiments, the top of the optical bridge 440 may be coplanar with a top of the photonics interposers 430 or below a top of the photonics interposers 430. Any gap between the photonics interposers 430 and the optical bridge 440, if present, may be filled with an index matching epoxy in some embodiments.

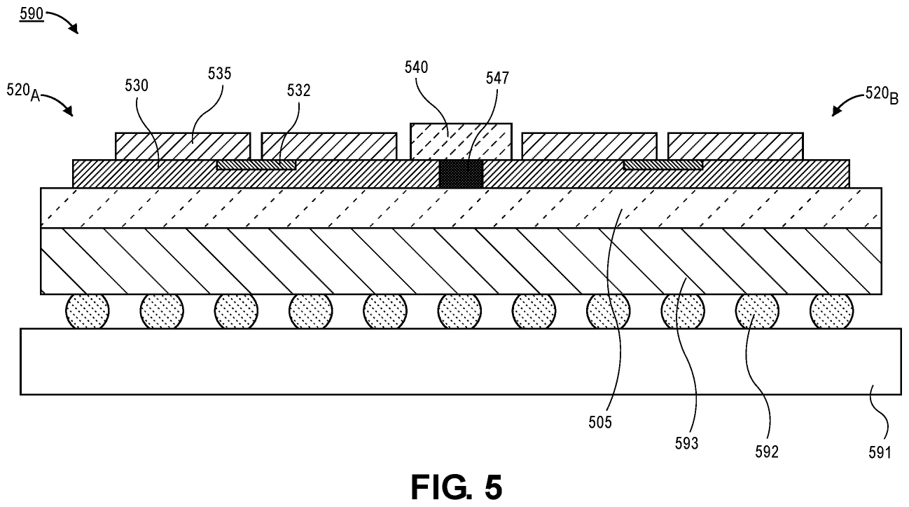

Referring now to FIG. 5, a cross-sectional illustration of a photonics system 590 is shown, in accordance with an embodiment. In an embodiment, the photonics system 590 comprises a board 591, such as a printed circuit board (PCB). In an embodiment, the board 591 may be coupled to a package substrate 593 by interconnects 592, such as solder balls or the like. In an embodiment, the package substrate 593 may be coupled to the base substrate 505. In other embodiments, the base substrate 505 may be coupled to the board 591 without an intervening package substrate 593. The base substrate 505 may comprise glass or any other suitable package substrate material.

In an embodiment, the photonics system 590 may further comprise two or more photonics modules 520. For example, two photonics modules 520_{A} and 520_{B} are shown in FIG. 5. In an embodiment, each photonics module 520 comprises a photonics interposer 530 and a plurality of dies 535. The plurality of dies 535 may be optically coupled together by waveguides 532 in the photonics interposer 530. The photonics interposer 530 and the plurality of dies 535 may be substantially similar to any of the photonics interposers or dies described in greater detail above.

In an embodiment, the photonics modules 520 may be optically coupled to each other by an optical bridge 540. The optical bridge 540 may comprise one or more waveguides that optically couple with waveguides in the photonics interposers 530. For example, grating couplers, evanescent couplers, butt couplers, or any other coupling architecture may be used to couple the optical bridge 540 to the photonics interposers 530. In an embodiment, an underfill 547 may be provided below the optical bridge 540 between the photonics interposers 530. While a particular photonics package is shown as part of the photonics system 590, it is to be appreciated that any photonics package described herein may be similarly integrated into a photonics system 590.

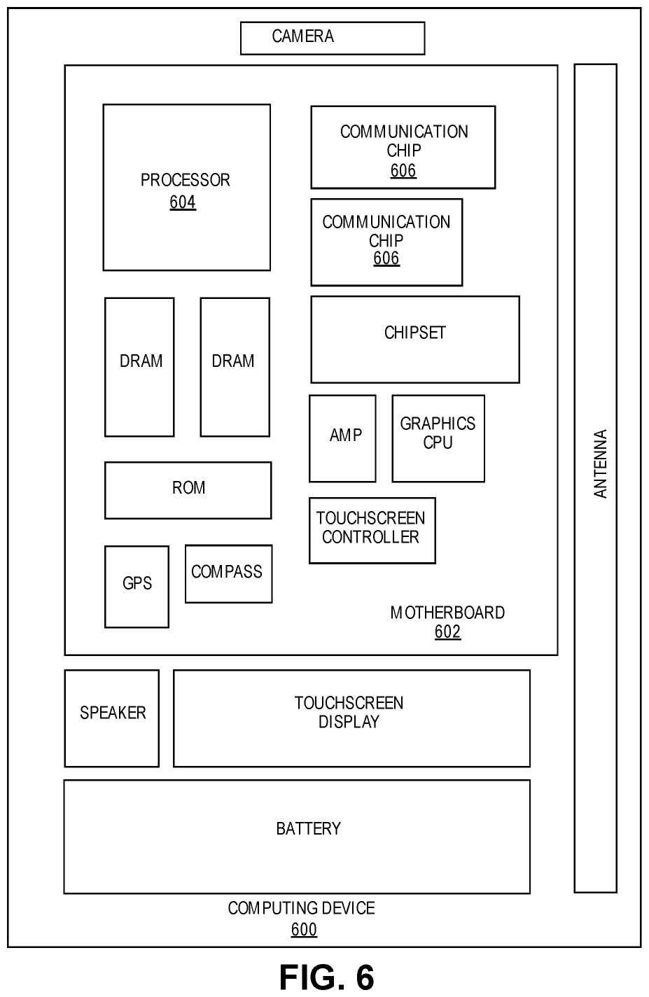

FIG. 6 illustrates a computing device 600 in accordance with one implementation of the invention. The computing device 600 houses a board 602. The board 602 may include a number of components, including but not limited to a processor 604 and at least one communication chip 606. The processor 604 is physically and electrically coupled to the board 602. In some implementations the at least one communication chip 606 is also physically and electrically coupled to the board 602. In further implementations, the communication chip 606 is part of the processor 604.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 606 enables wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others.

The processor 604 of the computing device 600 includes an integrated circuit die packaged within the processor 604. In some implementations of the invention, the integrated circuit die of the processor may be part of a photonics package that comprises a pair of photonics modules that are optically coupled together by an optical bridge, in accordance with embodiments described herein. The term “processor” may refer to any device or portion of a device that processes electronic data from registers and/or memory to transform that electronic data into other electronic data that may be stored in registers and/or memory.

The communication chip 606 also includes an integrated circuit die packaged within the communication chip 606. In accordance with another implementation of the invention, the integrated circuit die of the communication chip may be part of a photonics package that comprises a pair of photonics modules that are optically coupled together by an optical bridge, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a photonics package, comprising: a substrate; a first interposer over the substrate; a first die on the first interposer; a second interposer over the substrate; a second die on the second interposer; and an optical bridge between the first interposer and the second interposer.

Example 2: the photonics package of Example 1, wherein the first interposer and the second interposer are photonics interposers.

Example 3: the photonics package of Example 2, wherein the first interposer and the second interposer each comprise a photodetector and a modulator.

Example 4: the photonics package of Example 3, wherein the photodetector is a microring photodetector, and wherein the modulator is a microring modulator.

Example 5: the photonics package of Examples 1-4, wherein the optical bridge comprises a bridge waveguide that is optically coupled to a first waveguide in the first interposer and a second waveguide in the second interposer.

Example 6: the photonics package of Example 5, wherein the optical coupling between the bridge waveguide and the first waveguide and the second waveguide is through grating couplers.

Example 7: the photonics package of Example 5, wherein the optical coupling between the bridge waveguide and the first waveguide and the second waveguide is through evanescent coupling.

Example 8: the photonics package of Examples 1-7, wherein the optical bridge is over top surfaces of the first interposer and the second interposer.

Example 9: the photonics package of Examples 1-8, wherein the optical bridge is embedded in the substrate.

Example 10: the photonics package of Examples 1-9, wherein the optical bridge comprises a bridge waveguide that has a turn.

Example 11: the photonics package of Example 10, wherein the bridge waveguide is formed with a laser writing process.

Example 12: the photonics package of Examples 1-11, wherein a third die is provided on the first interposer, and wherein a fourth die is provided on the second interposer.

Example 13: the photonics package of Example 12, wherein the first die is optically coupled to the third die by a first waveguide in the first interposer, and wherein the second die is optically coupled to the fourth die by a second waveguide in the second interposer.

Example 14: a photonics package, comprising: a first photonics module comprising: a first plurality of dies operating in an electrical regime; a first photonics interposer to optically couple the first plurality of dies together; a second photonics module, comprising: a second plurality of dies operating in the electrical regime; a second photonics interposer to optically couple the second plurality of dies together; and an optical bridge, wherein the optical bridge optically couples the first photonics module to the second photonics module.

Example 15: the photonics package of Example 14, wherein the optical bridge spans a gap between the first photonics interposer and the second photonics interposer.

Example 16: the photonics package of Example 14 or Example 15, wherein the optical bridge is embedded in a substrate under the first photonics module and the second photonics module.

Example 17: the photonics package of Examples 14-16, wherein the first photonics interposer and the second photonics interposer both comprise a modulator and a photodetector.

Example 18: the photonics package of Example 17, wherein the modulator is a microring modulator, and wherein the photodetector is a microring photodetector.

Example 19: the photonics package of Examples 14-18, wherein the optical bridge is optically coupled to the first photonics interposer and the second photonics interposer with grating couplers.

Example 20: the photonics package of Examples 14-18, wherein the optical bridge is optically coupled to the first photonics interposer and the second photonics interposer with evanescent couplers.

Example 21: the photonics package of Examples 14-20, wherein the first photonics interposer and the second photonics interposer are provided over a substrate, wherein the substrate comprises glass or an organic material.

Example 22: a photonics system, comprising: a board; a package substrate over the board; a first photonics module over the package substrate; a second photonics module over the package substrate; and an optical bridge to optically couple the first photonics module to the second photonics module.

Example 23: the photonics system of Example 22, wherein the first photonics module comprises a first photonics interposer and a first plurality of dies, and wherein the second photonics module comprises a second photonics interposer and a second plurality of dies.

Example 24: the photonics system of Example 23, wherein the optical bridge is on top surfaces of the first photonics interposer and the second photonics interposer.

Example 25: the photonics system of Examples 22-23, wherein the package substrate comprises glass.

1. A photonics package, comprising:
a substrate;
a first interposer over the substrate;
a first die on the first interposer;
a second interposer over the substrate;
a second die on the second interposer; and
an optical bridge between the first interposer and the second interposer.

2. The photonics package of claim 1, wherein the first interposer and the second interposer are photonics interposers.

3. The photonics package of claim 2, wherein the first interposer and the second interposer each comprise a photodetector and a modulator.

4. The photonics package of claim 3, wherein the photodetector is a microring photodetector, and wherein the modulator is a microring modulator.

5. The photonics package of claim 1, wherein the optical bridge comprises a bridge waveguide that is optically coupled to a first waveguide in the first interposer and a second waveguide in the second interposer.

6. The photonics package of claim 5, wherein the optical coupling between the bridge waveguide and the first waveguide and the second waveguide is through grating couplers.

7. The photonics package of claim 5, wherein the optical coupling between the bridge waveguide and the first waveguide and the second waveguide is through evanescent coupling.

8. The photonics package of claim 1, wherein the optical bridge is over top surfaces of the first interposer and the second interposer.

9. The photonics package of claim 1, wherein the optical bridge is embedded in the substrate.

10. The photonics package of claim 1, wherein the optical bridge comprises a bridge waveguide that has a turn.

11. The photonics package of claim 10, wherein the bridge waveguide is formed with a laser writing process.

12. The photonics package of claim 1, wherein a third die is provided on the first interposer, and wherein a fourth die is provided on the second interposer.

13. The photonics package of claim 12, wherein the first die is optically coupled to the third die by a first waveguide in the first interposer, and wherein the second die is optically coupled to the fourth die by a second waveguide in the second interposer.

14. A photonics package, comprising:
a first photonics module comprising:
a first plurality of dies operating in an electrical regime;
a first photonics interposer to optically couple the first plurality of dies together;
a second photonics module, comprising:
a second plurality of dies operating in the electrical regime;
a second photonics interposer to optically couple the second plurality of dies together; and
an optical bridge, wherein the optical bridge optically couples the first photonics module to the second photonics module.

15. The photonics package of claim 14, wherein the optical bridge spans a gap between the first photonics interposer and the second photonics interposer.

16. The photonics package of claim 14, wherein the optical bridge is embedded in a substrate under the first photonics module and the second photonics module.

17.-21. (canceled)

22. A photonics system, comprising:
a board;
a package substrate over the board;
a first photonics module over the package substrate;
a second photonics module over the package substrate; and
an optical bridge to optically couple the first photonics module to the second photonics module.

23. The photonics system of claim 22, wherein the first photonics module comprises a first photonics interposer and a first plurality of dies, and wherein the second photonics module comprises a second photonics interposer and a second plurality of dies.

24. The photonics system of claim 23, wherein the optical bridge is on top surfaces of the first photonics interposer and the second photonics interposer.

25. The photonics system of claim 22, wherein the package substrate comprises glass.
